(19) United States
(12) Patent Application Publication
(10) Pub. No.: US 2004/0169832 A1
(43) Pub. Date: Sep. 2, 2004

(54) Vacuum chamber having instrument-mounting bulkhead exhibiting reduced deformation in response to pressure differential, and energy-beam systems comprising same

(75) Inventor: Toshimasa Shimoda, Ageoshi (JP)

Correspondence Address: KLARQUIST SPARKMAN, LLP, 121 SW SALMON STREET, SUITE 1600, PORTLAND, OR, 97204, US

(73) Assignee: Nikon Corporation

(21) Appl. No.: 10/798,630

(22) Filed: Mar. 10, 2004

Related U.S. Application Data
(63) Continuation-in-part of application No. 10/209,738, filed on Jul. 31, 2002.

(30) Foreign Application Priority Data
Aug. 24, 2001 (JP) 2001-253918

(51) Int. Cl. G03B 27/52

(52) U.S. Cl. 355/30

(57) ABSTRACT

Reduced-pressure (“vacuum”) chambers, and microlithographic exposure systems including one or more of such chambers, are disclosed. The vacuum chamber exhibits reduced deformation of a bulkhead of the chamber during evacuation of the chamber during a change in pressure differential across the bulkhead. A secondary wall is situated relative to the bulkhead outside the chamber and at a gap distance from the bulkhead, so as to form a secondary reduced-pressure chamber in the gap. The secondary reduced-pressure chamber is isolated from the pressure outside the chamber and from the subatmospheric pressure inside the chamber. The differential between the pressure outside the chamber and the pressure inside the secondary reduced-pressure chamber is exerted on the secondary wall, but has substantially no effect on the bulkhead, thereby reducing deformation of the bulkhead. Reducing bulkhead deformation prevents degradations of performance accuracy, otherwise caused by pressure-change-induced deformation of the bulkhead, of any instruments mounted to the bulkhead.

### CROSS REFERENCE TO RELATED APPLICATION

This application is a continuation-in-part of, and claims the benefit of, co-pending U.S. patent application Ser. No. 10/209,738, filed on Jul. 31, 2002. The entire '738 application is incorporated by reference into the instant application.

### FIELD

This disclosure pertains to systems in which a workpiece is placed inside a chamber evacuated to a subatmospheric pressure. Such systems are used, for example, in any of various irradiation and transfer-exposure apparatus that irradiate an object with an energy beam inside such a chamber or that contain an object for observation or tests performed on the object. The disclosure also pertains to microlithography systems, comprising at least one such chamber, that include one or more measuring instruments (e.g., position-measuring and/or alignment-measuring instruments) mounted to a bulkhead of such a chamber. The chamber is configured to prevent reductions in the operational accuracy and precision of the instrument(s) by controlling deformation of the bulkhead caused by evacuation of the chamber or by changes in the pressure differential across the chamber bulkhead.

### BACKGROUND

Many types of apparatus are known that utilize a charged particle beam (e.g., electron beam) or other energy beam for imaging, displaying, workpiece processing, or other practical application. An exemplary apparatus of this general type is a projection-exposure apparatus, also termed a “microlithography” system, used for transferring a pattern to a suitable substrate. Whereas most conventional microlithography systems utilize a beam of vacuum ultraviolet light for making the exposure, an emerging class of microlithography systems utilizes a charged particle beam (e.g., electron beam or ion beam) or an X-ray beam for making the exposure.

The summary below is set forth in the context of an electron-beam (EB) microlithography system, by way of example, which is used mainly for transferring intricate circuit patterns for integrated circuits and the like onto semiconductor wafers. In a typical EB microlithography system an electron beam is directed onto a layer of “resist” coated on a surface of a semiconductor wafer. Since an electron beam is blocked, and thus attenuated, by collisions with gas molecules, the inside of the microlithography system (especially in the beam trajectory) is maintained at high vacuum.

To create and contain the high-vacuum environment, a vacuum chamber is used. In the context of EB microlithography systems, exemplary vacuum chambers include vacuum chambers configured for holding a substrate (“wafer”) undergoing lithography and vacuum chambers configured for holding a reticle defining, for example, a pattern to be transferred lithographically to the substrate. The vacuum chamber typically is defined by at least one bulkhead and additional walls as required. The “bulkhead” is a stationary wall characterized by increased strength and rigidity (compared to other walls) for use as a mounting support for any of various instruments, windows, optical components, and other things in the vacuum chamber. Whenever this vacuum chamber is evacuated to a high vacuum, the walls (including the bulkhead) of the vacuum chamber exhibit some deformation due to the resulting pressure differential of the inside of the chamber (high vacuum) versus the outside of the chamber (normally at ambient atmospheric pressure). Changes in atmospheric pressure also can cause an accompanying change in deformation of the chamber walls and bulkhead. Whenever a bulkhead of such a chamber deforms, the attitude and position of, for example, a measuring instrument attached to the bulkhead change accordingly. For example, in an EB microlithography system, certain auto-focus (AF) and alignment (AL) instruments and/or optical microscopes or the like typically are installed on a bulkhead of the vacuum chamber. A change in attitude or position of an AF or AL instrument mounted on a bulkhead experiencing deformation can produce a corresponding decrease in the accuracy of pattern transfer performed in the chamber using the microlithography system.

According to conventional thinking, the way to prevent deformation of a bulkhead of a vacuum chamber (and the consequential adverse effect on accuracy of AF and AL instruments mounted on the bulkhead) is to increase the rigidity and stoutness of the bulkhead by forming, for example, strong ribs on the bulkhead and/or by constructing the bulkhead of a material having a relatively high Young's modulus. However, with such approaches, increasingly stringent demands for measurement accuracy and precision of AF and AL systems are accompanied by corresponding substantial increases in the size and mass of the overall vacuum-chamber structure, which unavoidably increases the overall size and cost of the apparatus. Therefore, other countermeasures are needed to avoid this trend.

### SUMMARY

In view of the problems experienced with conventional apparatus and methods as summarized above, the invention provides, inter alia, systems respectively comprising a vacuum chamber that is more resistant to decreases in the accuracy and precision of instruments mounted on a bulkhead of the vacuum chamber. These ends are met by reducing the effects of deformation of the chamber bulkhead during evacuation of the chamber or during changes in the pressure differential of the pressure inside the chamber relative to the pressure outside the chamber.

According to a first aspect of the invention, chambers are provided for holding an object (e.g., a workpiece) at a pressure that is lower (i.e., higher vacuum) inside the chamber than outside the chamber. An embodiment of such a chamber comprises walls and at least one bulkhead that collectively define the chamber. A secondary wall is situated outside the chamber relative to the bulkhead, and defines a gap between the secondary wall and the bulkhead. The gap defines a secondary reduced-pressure chamber that is maintained at a pressure that is lower than the pressure outside the chamber. For example, if the inside of the chamber is maintained at a particular vacuum level, the pressure maintained in the secondary reduced-pressure chamber can be less than (i.e., at a higher vacuum level than) the pressure inside the chamber and the pressure outside the chamber (the latter usually being atmospheric pressure). Alternatively, the pressure maintained in the secondary reduced-pressure chamber can be intermediate the pressure outside the chamber and the pressure inside the chamber. In either case, the pressure inside the secondary reduced-pressure chamber is lower than the pressure outside the chamber. The secondary wall is deformable relative to the bulkhead in response to this differential of pressure inside the secondary reduced-pressure chamber relative to outside the chamber. The secondary reduced-pressure chamber desirably is isolated from the pressure outside the chamber and from the pressure inside the chamber.

As noted above, the chamber can be configured to be evacuated to a particular vacuum level relative to atmospheric pressure outside the chamber. In this and other configurations, the secondary reduced-pressure chamber can be connected to a vacuum pump configured to evacuate the secondary reduced-pressure chamber to a lower pressure than outside the chamber.

The chamber further can comprise a measurement instrument and a seal means. In this configuration the measurement instrument is mounted to the bulkhead and has a portion extending through the secondary wall to outside the chamber. The seal means is situated and configured to establish a seal between the secondary wall and the measurement instrument such that the secondary wall can move relative to the bulkhead (and hence relative to the measurement instrument), without breaching the seal, in response to the differential of pressure. The measurement instrument can be configured to measure a characteristic of the object inside the chamber. The seal means can comprise an elastomeric sealing member extending from the secondary wall to the measurement instrument.

By way of example, the chamber can be a wafer chamber of a microlithography system, wherein the object is a semiconductor wafer being exposed lithographically in the wafer-vacuum chamber. In this configuration the measurement instrument can be used for measuring at least one of position and alignment of the wafer inside the wafer-vacuum chamber. Alternatively, the chamber can be a reticle-vacuum chamber of a microlithography system, wherein the object is a reticle, and the measurement instrument can be used for measuring at least one of position and alignment of the reticle inside the reticle-vacuum chamber.

The relative pressures inside the chamber, inside the secondary reduced-pressure chamber, and the pressure outside the chamber can be as summarized earlier above.

According to another aspect of the invention, apparatus are provided for housing an object in a subatmospheric-pressure environment. An embodiment of such an apparatus comprises a chamber collectively defined by vessel walls and at least one bulkhead. The chamber is sized to contain the object and to contain an atmosphere evacuated to the subatmospheric pressure. The apparatus includes at least one instrument mounted to the bulkhead outside the chamber, wherein the instrument is configured to measure a characteristic of the object in the chamber. The apparatus also includes a deformation-reducing device for reducing deformation of the bulkhead in response to the pressure differential of the subatmospheric pressure inside the chamber relative to the pressure outside the chamber. The deformation-reducing device desirably comprises a secondary wall situated outside the chamber relative to the bulkhead and defining a gap between the bulkhead and the secondary wall, wherein the gap defines a secondary reduced-pressure chamber that is evacuated to a pressure that is lower than the pressure outside the chamber. The secondary wall desirably deforms relative to the bulkhead in response to the pressure differential of the pressure inside the secondary reduced-pressure chamber relative to the pressure outside the chamber, thereby greatly reducing deformation of the bulkhead. The apparatus further can comprise a seal means and/or vacuum pump as summarized above.

The apparatus further can comprise a stage situated inside the chamber and configured to hold the object inside the chamber. If the object is a reticle or substrate, then the stage can be, for example, a reticle stage or wafer stage, respectively, of a microlithographic projection-exposure system. In this instance, the instrument can be, for example, a reticle-autofocus device, a reticle-alignment device, a wafer-autofocus device, or a wafer-alignment device.

According to another aspect of the invention, systems are provided for irradiating an object with an energy beam. An embodiment of such a system comprises a chamber collectively defined by vessel walls and at least one bulkhead. The chamber is sized to contain the object for irradiation with the energy beam and to contain an atmosphere evacuated, at least during the irradiation, to a desired subatmospheric pressure. The system also includes an optical system situated so as to irradiate the object in the chamber with the energy beam. The system also includes an instrument mounted to the bulkhead outside the chamber, wherein the instrument is configured to measure a characteristic of the object in the chamber. The system also includes a deformation-reducing device for reducing deformation of the bulkhead in response to the differential of pressure inside the chamber relative to pressure outside the chamber. The deformation-reducing device desirably comprises a secondary wall situated outside the chamber relative to the bulkhead and defining a gap between the bulkhead and the secondary wall, wherein the gap defines a secondary reduced-pressure chamber that is evacuated to a pressure that is lower than the pressure outside the chamber.

As summarized above, the secondary wall desirably is configured to deform relative to the bulkhead in response to the differential of pressure inside the secondary reduced-pressure chamber relative to the pressure outside the chamber. The system further can include a seal means and/or vacuum pump as summarized above.

If the object is a lithographic wafer substrate, then the optical system can be a projection-optical system situated relative to the chamber and configured to illuminate the substrate inside the chamber with an energy beam so as to expose the substrate lithographically. In this configuration the energy beam can be, for example, a beam of electromagnetic radiation (e.g., vacuum-UV light, extreme UV light, or X-ray light) or a charged particle beam.

According to yet another aspect of the invention, lithographic exposure systems are provided for exposing a substrate with a pattern. An embodiment of such a system comprises a first chamber collectively defined by respective chamber walls and at least one respective bulkhead. The first chamber is configured: (a) to contain the substrate for exposure, (b) to allow irradiation of the substrate with an energy beam capable of imprinting the pattern on the substrate, and (c) to contain an atmosphere evacuated, at least during the exposure, to a respective subatmospheric pressure. The system also includes an energy-beam source situated relative to the first chamber to direct the energy beam into the first chamber to expose the substrate. The source can comprise a projection-optical system mounted to the bulkhead of the first chamber. A respective instrument is mounted to the respective bulkhead, wherein the instrument is configured to measure a characteristic (such as position and/or alignment) of the substrate in the first chamber. The system includes a respective deformation-reducing device for reducing deformation of the bulkhead of the first chamber in response to the differential of pressure inside the first chamber relative to the pressure outside the first chamber.

The system further can comprise a second chamber collectively defined by respective chamber walls and at least one respective bulkhead. The second chamber is configured: (a) to contain a reticle, (b) to allow irradiation of the reticle with an illumination beam, (c) to allow the illumination beam, propagating downstream of the reticle, to pass from the second chamber to the first chamber, and (d) to contain an atmosphere evacuated, at least during irradiation, to a respective subatmospheric pressure. An illumination-optical system is situated relative to the second chamber and configured to direct the illumination beam into the second chamber to illuminate the reticle. A respective instrument is mounted to the respective bulkhead, wherein the instrument is configured to measure a characteristic (e.g., position and/or alignment) of the reticle in the second chamber. The system includes a respective deformation-reducing device for reducing deformation of the bulkhead of the second chamber in response to the differential of pressure inside the second chamber relative to pressure outside the second chamber.

With respect to either chamber, the respective deformation-reducing device desirably comprises a respective secondary wall situated outside the respective chamber relative to the respective bulkhead. The secondary wall defines a gap, between the bulkhead and the secondary wall, that defines a respective secondary reduced-pressure chamber that is evacuated to a subatmospheric pressure that is lower than the pressure outside the respective chamber. The secondary wall desirably is configured to deform relative to the respective bulkhead in response to the differential of pressure inside the respective secondary reduced-pressure chamber relative to pressure outside the respective chamber, thereby preventing deformation of the respective bulkhead. Each secondary reduced-pressure chamber can include a respective seal means and/or vacuum pump as summarized above. The vacuum pump can be configured to change the subatmospheric pressure in the respective secondary reduced-pressure chamber in response to a change in pressure outside the respective chamber and/or a change in pressure inside the respective chamber.

According to yet another aspect of the invention, methods are provided (in the context of any of various methods involving holding a workpiece or other object under a subatmospheric-pressure condition established within a chamber collectively defined by vessel walls and at least one bulkhead) for reducing deformations of the bulkhead resulting from changes in the differential of pressure inside the chamber relative to pressure outside the chamber. An embodiment of such a method comprises placing a secondary wall outside the chamber relative to the bulkhead so as to define a gap between the secondary wall and the bulkhead, wherein the gap defines a secondary reduced-pressure chamber. The secondary reduced-pressure chamber is evacuated to a subatmospheric pressure that is lower than the pressure outside the chamber, wherein the secondary wall deforms relative to the bulkhead in response to a pressure differential, as summarized above.

According to yet another aspect of the invention, microlithography systems are provided that illuminate a selected region on a reticle with an energy beam and that project and focus the energy beam, propagating from the reticle, onto a selected region on a sensitive substrate so as to transfer features from the reticle to the sensitive substrate. An embodiment of such a system comprises a reticle-vacuum chamber containing a reticle stage or other reticle holder on which the reticle is mounted. The reticle-vacuum chamber is defined by respective walls and at least one respective bulkhead. The system also includes a wafer-vacuum chamber that contains a wafer stage or other substrate holder, on which the sensitive substrate is mounted, wherein the wafer-vacuum chamber is defined by respective walls and at least one respective bulkhead. A respective instrument is mounted on the bulkhead of the reticle-vacuum chamber for measuring a characteristic of the reticle, and a respective instrument is mounted on the bulkhead of the wafer-vacuum chamber for measuring a characteristic of the substrate. For at least one of the chambers, a respective deformation-reducing device is provided for reducing deformation of the respective bulkhead in response to a pressure differential, as summarized above.

The deformation-reducing device desirably comprises a respective secondary wall situated outside the respective chamber relative to the respective bulkhead and defining a gap between the respective bulkhead and respective secondary wall. The gap defines a respective secondary reduced-pressure chamber that is evacuated to a respective pressure that is lower than the pressure outside the respective chamber. The secondary wall desirably deforms relative to the respective bulkhead in response to a pressure differential, as summarized above. The system can include a seal means and/or vacuum pump as summarized above.

In a more specific embodiment of the system, a first deformation-reducing device is provided for reducing deformation of the bulkhead of the reticle-vacuum chamber, and a second deformation-reducing device is provided for reducing deformation of the bulkhead of the wafer-vacuum chamber, in response to respective pressure differentials. In this system, each deformation-reducing device desirably comprises a respective secondary wall situated outside the respective chamber relative to the respective bulkhead and defining a gap between the respective bulkhead and respective secondary wall. Each gap defines a respective secondary reduced-pressure chamber that is evacuated to a respective pressure that is lower than the pressure outside the respective chamber. As noted above, each secondary wall desirably is configured to deform relative to the respective bulkhead in response to pressure differentials. Seal means and vacuum pumps, as summarized above, can be included.

An instrument can be mounted on the bulkhead of the reticle-vacuum chamber. This instrument can be, for example, a reticle-position-measurement system (e.g., a reticle-autofocus system) or a reticle-alignment-measurement system. Similarly, an instrument can be mounted on the bulkhead of the wafer-vacuum chamber. This instrument can be, for example, a substrate-position-measurement system (e.g., a substrate-autofocus system) or a substrate-alignment-measurement system.

The bulkhead of the reticle-vacuum chamber and the bulkhead of the wafer-vacuum chamber can be mounted to opposite respective ends of a projection-optical system extending between and outside the chambers. In such a system the bulkhead of the reticle-vacuum chamber can be configured as a reticle-optical plate, and the bulkhead of the wafer-vacuum chamber can be configured as a wafer-optical plate. As used herein, an “optical plate” is a bulkhead especially configured, such as in terms of enhanced planarity, strength, and/or rigidity, for serving as a mounting foundation or base for optical components or an optical system mounted thereto.

The reticle-vacuum chamber can comprise a second bulkhead situated opposite the respective bulkhead, relative to the respective walls. In such a configuration the second bulkhead can be connected to an illumination-optical system.

The reticle-vacuum chamber can be coupled to a reticle-loader chamber and a reticle load-lock chamber, and the wafer-vacuum chamber can be coupled to a wafer-loader chamber and a wafer load-lock chamber, as desired or required.

Since the various systems summarized above include respective devices that reduce deformation of a bulkhead occurring during evacuation or other pressure change in the respective chamber, misalignments and/or positional shifts of instruments mounted on the bulkhead are reduced. This allows higher-accuracy work to be performed on an object or workpiece located in the respective chamber, such as workpiece measuring, workpiece processing, workpiece irradiation, or pattern transfer from a reticle to the workpiece.

Exemplary energy-beam irradiation systems include, but are not limited to, lithographic-exposure systems, coordinate-measurement systems, scanning electron microscopes, etc. Exemplary instruments include, but are not limited to, autofocus (AF) devices (see, e.g., Japan Kôkai Patent Document Nos. Hei 6-283403 and Hei 8-64506, referred to herein as “AF” devices), alignment devices (see, e.g., Japan Kôkai Patent Document No. Hei 5-21314, referred to herein as “AL” devices), and interferometers.

With respect to any of the secondary reduced-pressure chambers referred to above, by making the pressure inside the chamber and the pressure inside the secondary reduced-pressure chamber nearly equal to each other, deformation of the bulkhead is further reduced. This is because, under such conditions, the differential of internal versus external pressure across the bulkhead has virtually no effect on the bulkhead, especially near instruments mounted to the bulkhead. If there is a change in the pressure differential, then the respective secondary wall (rather than the bulkhead) is deformed. Also, by moving the secondary wall instead of the bulkhead in response to the pressure differential, any instruments mounted on the bulkhead experience correspondingly less disturbance in response to the change in pressure differential. The seal means established between the secondary wall and the instruments or their mountings can be configured as a sliding or otherwise deformable gasket between the instruments (or instrument mounts) and the secondary wall. The seal means can be, for example, O-rings or diaphragms extending between the secondary wall and the instrument mounts or instruments.

Reducing deformation of the bulkhead generally results in substantially reduced tilting, misalignment, distortion, or other undesired movement of the instrument(s) mounted to it. For example, a “distortion” to an instrument can arise in a situation in which there is no actual tilting of the instrument itself but rather a shift of the position of the instrument relative to an object inside the chamber that is being monitored by the instrument. If this distortion is very slight, the measurement accuracy of the instrument is not affected significantly in many instances. But, a more pronounced distortion (as experienced in conventional apparatus) substantially can reduce the performance accuracy of the instrument.

The pressure inside a secondary reduced-pressure chamber can be regulated according to changes in the pressure outside the respective chamber. Thus, the positioning of instrument(s) and/or their respective mount(s) mounted to a bulkhead of the respective chamber can be optimized by intentional control of the pressure in the secondary reduced-pressure chamber.

The foregoing and additional features and advantages of the invention will be more readily apparent from the following detailed description, which proceeds with reference to the accompanying drawings.

### BRIEF DESCRIPTION OF THE DRAWINGS

FIG. 1 is a schematic elevational diagram showing the overall configuration of a representative embodiment of a microlithographic projection-exposure system.

FIG. 2 is a plan view of an exemplary wafer-optical plate of the microlithographic exposure system of FIG. 1, showing certain components associated with this particular wafer-optical plate.

FIG. 3 is an elevational section, along the line X-X, of the wafer-optical plate of FIG. 2, showing the location of the wafer auto-focus (AF) device.

FIG. 4 is an enlarged elevational section showing details of the wafer AF device shown in FIG. 3.

FIG. 5 is an elevational section viewed in the direction of the arrow Y in FIG. 4.

FIG. 6(a) is a schematic elevational depiction of deformation of the wafer-optical plate that occurs whenever no secondary wall is provided in association with the wafer-optical plate.

FIG. 6(b) schematically shows the absence of deformation of the wafer-optical plate achieved by including a secondary wall in association with the wafer-optical plate.

FIG. 7 is a schematic elevational diagram showing certain optical relationships in a charged-particle-beam (notably electron-beam) microlithography system.

### DETAILED DESCRIPTION

Several representative embodiments are described below that are not intended to be limiting in any way. Also, the description is made largely in the context of an electron-beam microlithography system as a representative charged-particle-beam (CPB) microlithography system and as a representative system employing a vacuum chamber. It will be understood that the details described below can be applied with equal facility to any of various other types of microlithography systems and to other systems employing a vacuum chamber, such as an ion-beam, X-ray, or extreme ultraviolet (EUV) microlithography system or other system that utilizes one or more charged particle beams or beams of electromagnetic radiation.

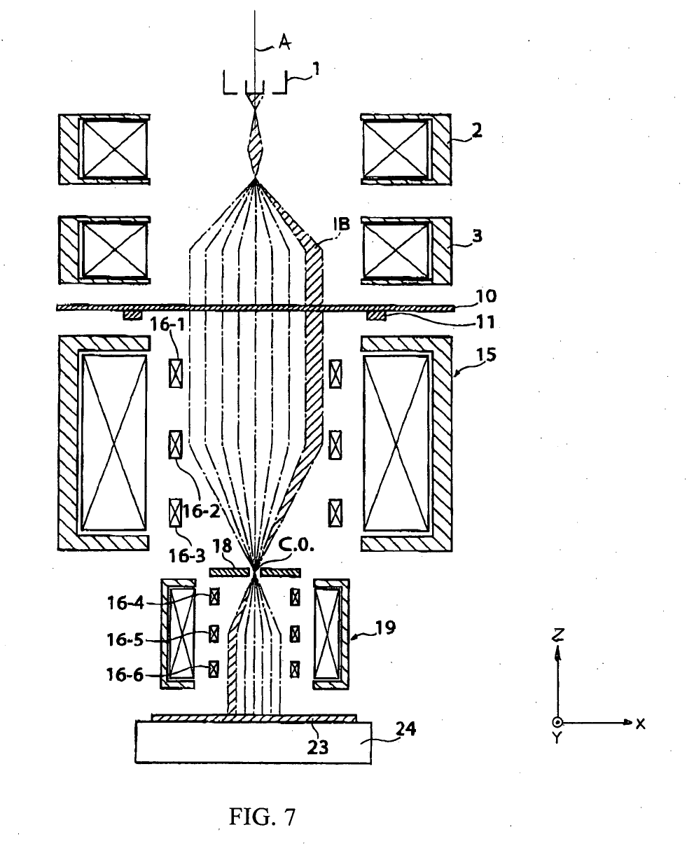

An overview of the overall construction of an exemplary electron-beam (EB) projection-microlithography system and of the imaging relationships in such a system is provided in FIG. 7. In the depicted system, an electron gun 1 is situated at the extreme upstream end of an EB optical system and emits an electron beam (“illumination beam” IB) in the downstream direction. A condenser lens 2 and an illumination lens 3 are situated downstream of the electron gun 1, and the illumination beam IB passes through the lenses 2, 3 to illuminate a pattern-defining reticle 10.

In FIG. 7, the EB optical system upstream of the reticle 10 (termed the “illumination-optical system”) also includes other components such as a shaping aperture, a blanking deflector, a blanking aperture, and an illumination-beam deflector that are not shown but are well understood in the art. The primary components in the illumination-optical system are the lenses 2, 3. The illumination beam IB, shaped and appropriately deflected in the illumination-optical system, sequentially scans the reticle 10 to illuminate “subfields” on the reticle. Each subfield defines a respective portion of the overall pattern defined by the reticle 10. The lateral distance on the reticle over which the illumination beam IB is scanned is within the optical field of the illumination-optical system.

As noted above, the reticle 10 has a multiple subfields that typically are arranged on the reticle in a rectilinear array. The reticle is mounted on a movable reticle stage 11. Subfields on the reticle located outside the optical field of the illumination-optical system are brought to within the optical field (for illumination) by movement of the reticle stage 11 within a plane perpendicular to the optical axis A.

Downstream of the reticle 10 is the “projection-optical system” comprising a primary projection lens 15 and a secondary projection lens 19 for projecting and forming respective images of the illuminated subfields on appropriate locations on a “sensitive” substrate (resist-coated wafer) 23. The projection-optical system also includes deflectors 16 (denoted 16-1, 16-2, 16-3, 16-4, 16-5, 16-6 in the figure) used for aberration correction and for achieving a desired image registration on the wafer. Portions of the illumination beam passing through an illuminated subfield on the reticle 10 thus become a “patterned beam” that carries an aerial image of the illuminated subfield. The aerial image is formed at a specified position on the wafer 23 by means of the projection lenses 15, 19 and the deflectors 16. As noted, the upstream-facing surface of the wafer 23 is coated with a suitable resist that, upon receiving an appropriate “dose” of the patterned beam, becomes imprinted with the respective image. Thus, the pattern on the reticle 10 is transferred onto the wafer. The transferred image normally is demagnified according to a demagnification ratio (reduction ratio) of, e.g., 1/4.

A crossover C.O. is formed at a point on the optical axis at which the axial distance between the reticle 10 and wafer 23 is divided according to the demagnification ratio. A contrast aperture 18 is disposed at the position of the crossover. The contrast aperture 18 blocks electrons of the patterned beam that have experienced substantial forward-scattering during passage through non-patterned portions of the reticle 10. Thus, these scattered electrons do not reach the wafer 23.

The wafer 23 is mounted by an electrostatic chuck on a wafer stage 24 that is movable in the X and Y directions perpendicular to the optical axis A. By synchronously scanning the reticle stage 11 and wafer stage 24 in opposite directions, the various portions of the pattern situated beyond the optical field of the projection-optical system are exposed sequentially.

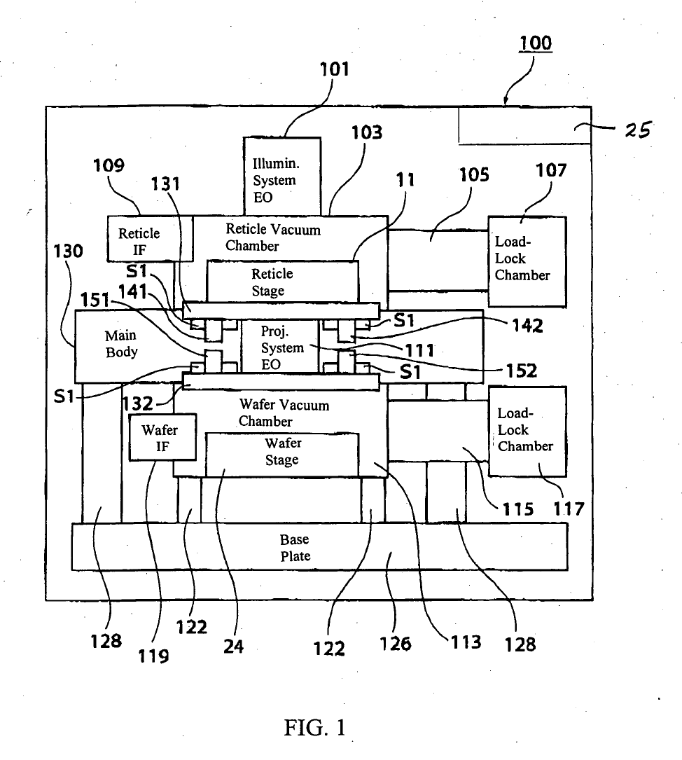

Turning now to FIGS. 1-5, an electron-beam projection-microlithography (“projection-exposure”) system 100 according to a representative embodiment is shown, wherein the system 100 is representative of any of various systems that include a vacuum chamber. In the depicted apparatus, an illumination-optical-system (IOS) column 101 is situated at the upstream end of the apparatus 100 (top of the figure, labeled the “illumination-system electron optics” (EO)). The electron gun 1, condenser lens 2, illumination lens 3, and other components of the illumination-optical system discussed above are disposed inside the IOS column 101. A reticle-vacuum chamber 103, situated just downstream of the IOS column 101, contains the reticle stage 11.

A reticle-loader chamber 105 and reticle load-lock chamber 107, shown at the right in FIG. 1, are connected to the reticle-vacuum chamber 103. A robotic manipulator (not shown), used for reticle handling, is situated inside the reticle-loader chamber 105. The manipulator operates, for example, to replace an existing reticle on the reticle stage 11 with a new reticle waiting inside the reticle-loader chamber 105. Whenever reticles are moved into the reticle-vacuum chamber 103 from outside the projection-exposure system or out of the reticle-vacuum chamber 103 to outside the projection-exposure system, such movements are made by the manipulator via the reticle-loader chamber 105 though the reticle load-lock chamber 107. Evacuation means, such as respective vacuum pumps (not shown, but well understood in the art), are connected to the reticle-vacuum chamber 103 and the reticle load-lock chamber 107. The interior of the IOS column 101, as well as the interior of the projection-optical-system (POS) column 111 discussed below, normally are evacuated to high vacuum.

A reticle interferometer (IF) 109, shown at the left in FIG. 1, extending into the reticle-vacuum chamber 103. The reticle interferometer 109 is connected to a controller 25. Accurate data regarding the position of the reticle stage 11 are produced by the reticle interferometer 109 and routed to the controller 25. The controller 25, in turn, produces reticle-movement commands routed to the reticle stage 11 as required in response to the reticle-position data. Thus, the position of the reticle stage 11 is controlled accurately in real time.

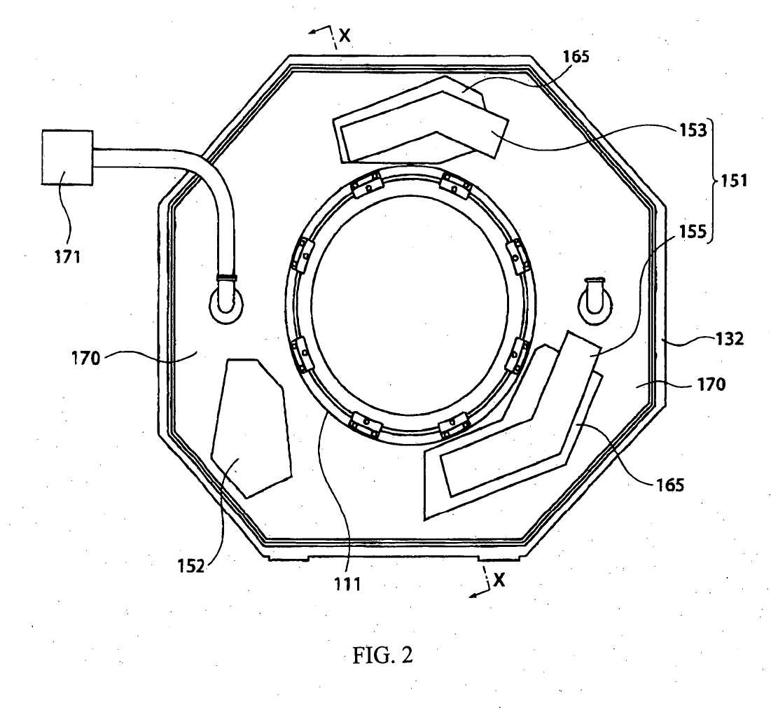

The reticle stage 11 is mounted to an upstream-facing surface of a “reticle-optical plate” 131 (serving as a chamber bulkhead and instrument-mounting plate for the reticle-vacuum chamber 103). Downstream of the reticle-vacuum chamber 103 is a wafer-vacuum chamber 113 described later below. The wafer-vacuum chamber 113 is defined in part by a “wafer-optical plate” 132 that is a bulkhead of the wafer-optical system. The POS column 111 is disposed between and mounted to the optical plates 131, 132. In the depicted embodiment, each optical plate 131, 132 is configured in this embodiment as a respective octagonal plate fabricated from mild steel plate or the like (see FIG. 2). The primary projection lens 15 and secondary projection lens 19 are disposed inside the POS column 111, which is evacuated to high vacuum.

A reticle-autofocusing (AF) system 141 and reticle-alignment (AL) system 142 (as exemplary “instruments”) are mounted on the downstream-facing (“bottom”) surface of the reticle-optical plate 131, and a wafer AF system 151 and wafer AL system 152 (as exemplary “instruments”) are mounted on the upstream-facing (“top”) surface of the wafer-optical plate 132, around the perimeter of the POS column 111, as discussed in detail below. A “main body” 130 extends between the two optical plates 131, 132.

The wafer-vacuum chamber 113 contains the wafer stage 24 and related components. A wafer-loader chamber 115 and wafer load-lock chamber 117, shown on the right in FIG. 1, are connected to the wafer-vacuum chamber 113. Evacuation means, such as respective vacuum pumps (not shown), are connected to the wafer-vacuum chamber 113 and the wafer load-lock chamber 117.

A wafer interferometer (IF) 119, shown at the left in FIG. 1, extends into the wafer-vacuum chamber 113. The wafer interferometer 119 is connected to the controller 25. Accurate data concerning the position of the wafer stage 24 are produced by the wafer interferometer 119 and routed to the controller 25. The controller 25, in turn, produces wafer-movement commands routed to the wafer stage 24 as required in response to the wafer-position data. Thus, the position of the wafer stage 24 is controlled accurately in real time.

The wafer-vacuum chamber 113 is supported by a stand 122 mounted to a base plate 126. The main body 130, discussed above, is supported on the base plate 126 by a stand 128 providing active attenuation of vibrations between the base plate 126 and the main body 130.

Exemplary structures associated with the wafer AF system 151 are shown in FIGS. 2-5. The respective structures of the wafer AF system 151 and reticle AF system 141 are similar to each other, and the respective structures of the wafer AL system 152 and reticle AL system 142 are similar to each other.

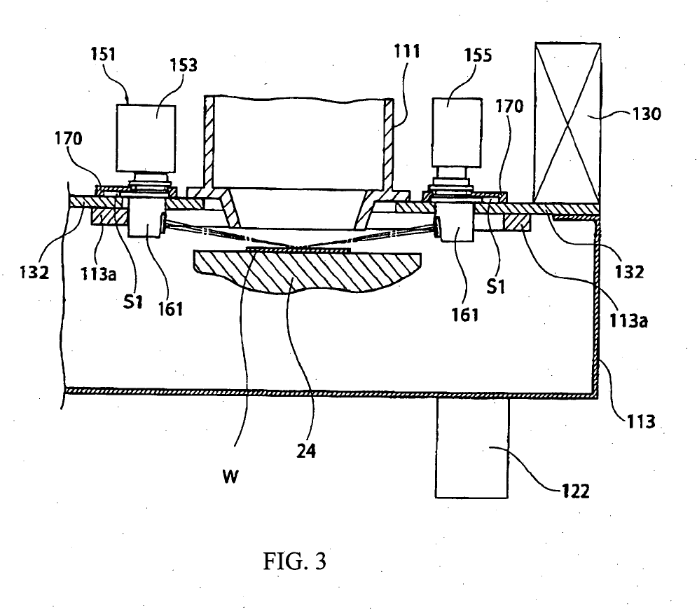

The wafer AF system 151, as shown in FIGS. 2-3, comprises a light-transmission device 153 and a light-reception device 155 mounted to the “outer” surface of the wafer-optical plate 132 (i.e., outside the wafer-vacuum chamber 113). The devices 153, 155 extend through the wafer-optical plate 132 into the interior of the wafer-vacuum chamber 113, and are situated on opposite sides of the POS column 111, with the POS column situated between them. Signal light emitted from the light-transmission device 153 impinges on the “top” (upstream-facing) surface of the wafer W on the wafer stage 24 inside the wafer-vacuum chamber 113, and signal light reflected from the wafer surface is received by the light-reception device 155. Meanwhile, the wafer AL system 152 (not shown in FIG. 3) is mounted to the outer surface of the wafer-optical plate 132 at a location just outside the perimeter of the POS column 111 and separately from the light-transmission device 153 and light-reception device 155 of the wafer AF system 151. Measurement data produced by the wafer AF system 151 pertain to the measured position of an existing pattern on the wafer or of a mark plate on the wafer stage 24. These data are used for registering the relative positions of the existing alignment-mark pattern provided on the wafer 23 or on a pattern to be formed next on the wafer.

The wafer AF system 151 can have a conventional configuration such as disclosed in Japan Kôkai Patent Publication No. Hei 6-283403 and Japan Kôkai Patent Publication No. Hei 8-64506, and the wafer AL system 152 can have a conventional configuration such as disclosed in Japan Kôkai Patent Publication No. Hei 5-21314.

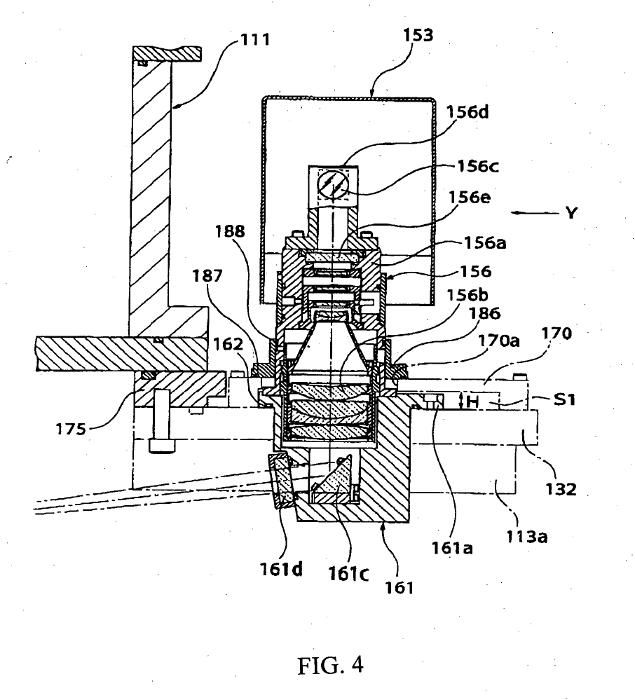

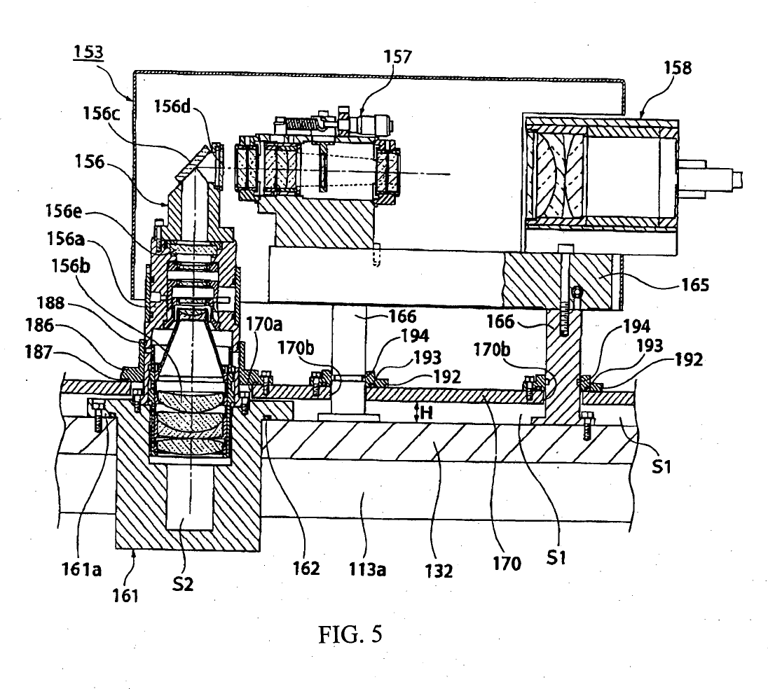

Structures in the vicinity of the light-transmission device 153 of the wafer AF system 151 are shown in FIGS. 4 and 5. Turning first to FIG. 5, the light-transmission device 153 comprises a vertical lens column 156, a horizontal lens column 157, and a light source 158. The vertical lens column 156 includes an objective lens 156b and vacuum-bulkhead window 156e situated at the “bottom” and “top,” respectively, of an AF lens column 156a. A mirror 156c and window 156d are situated at the “upper” end of the AF lens column 156a.

As shown in FIGS. 4 and 5, a box-shaped mirror chamber 161 is attached to the “bottom” of the AF lens column 156a. A flange 161a extends outward around the circumference of an opening at the “top” of the mirror chamber 161. The mirror chamber 161 extends from the outer surface of the wafer-optical plate through an opening in the wafer-optical plate 132 and through a corresponding opening in an upper lip 113a of the wafer-vacuum chamber 113, such that the “lower” portion of the mirror chamber 161 extends into the interior of the wafer-vacuum chamber 113. The flange 161a of the mirror chamber 161 is attached to the “top” surface (outer surface) of the wafer-optical plate 132, with an O-ring seal 162 therebetween. A mirror 161c and window 161d are situated inside the mirror chamber 161 (FIG. 4).

As shown in FIG. 5, the horizontal lens column 157 and light source 158 are attached to a platform 165. The platform 165 is supported firmly by legs 166 mounted to the “top” surface of the wafer-optical plate 132.

As shown in FIG. 2, a “pan” 170 is disposed over nearly the entire “top” surface of the wafer-optical plate 132. Thus, in this embodiment, the pan 170 is situated outside the wafer-vacuum chamber 113 relative to the wafer-optical plate 132. The pan 170 serves as a secondary wall to the wafer-optical plate 132 (the latter being an exemplary bulkhead), and defines a gap H (FIGS. 4 and 5) between the pan 170 and the wafer-optical plate 132. Thus, a secondary reduced-pressure chamber S1 is defined in the space between the pan 170 and the wafer-optical plate 132. The pan 170 desirably is made from a sheet of relatively low-mass metal, such as aluminum, to allow the pan to flex, as described further below. As shown in FIGS. 4 and 5, the pan 170 is situated “above” the flange 161a of the mirror chamber 161. The secondary reduced-pressure chamber S1 is connected to and evacuated by a vacuum pump (not shown in FIGS. 4 and 5, but see item 171 in FIG. 2). The secondary reduced-pressure chamber S1 is connected to a space S2, in which the mirror 161c is located, inside the mirror chamber 161.

The pan 170 defines a hole 170a through which the vertical lens column 156 extends and defines respective holes 170b through which the legs 166 of the stand 165 extend. An annular closure member 186 extends radially on the “top” surface of the pan 170 to close most of the space between the hole 170a and the outside diameter of the AF lens column 156a. The mounting of the closure member 186 to the pan 170 is sealed with an O-ring 187 (or analogous elastomeric seal, such as a diaphragm), and the space between the inside diameter of the closure member 186 and the outside diameter of the AF lens column 156a is sealed with an O-ring 188 (or analogous elastomeric seal). The O-ring 182 allows movement of the pan 170 relative to the AF lens column 156a. Meanwhile, respective annular closure members 192 extend radially on the “top” surface of the pan 170 to close respective spaces between the holes 170b and the outer surfaces of the legs 166. The mounting of each closure member 192 with the pan 170 is sealed with a respective O-ring 193, and the space between the inside diameter of each closure member 192 and the outside diameter of each leg 166 is sealed with a respective O-ring 194.

The secondary reduced-pressure chamber S1 between the pan 170 and the wafer-optical plate 132 is isolated from the environment outside the system (which is usually, but not necessarily, at atmospheric pressure) and from the vacuum environment inside the wafer-vacuum chamber 113. The vacuum pump 171 (FIG. 2) connected to the secondary reduced-pressure chamber S1 operates to reduce and regulate the pressure inside the secondary reduced-pressure chamber S1. A distortion sensor (not shown) can be mounted on the inner surface of the mirror chamber 161 or other suitable location for measuring deformation of the mirror chamber 161 and pan 170, allowing the pressure inside the secondary reduced-pressure chamber S1 to be regulated appropriately in real time.

Item 175 in FIG. 4 is an annular member situated between the “bottom” surface of the POS lens column 111 and the “top” surface of the wafer-optical plate 132. The annular member 175 desirably is made from a non-magnetic material, such as stainless steel, and serves to interrupt an electromagnetic circuit that otherwise could form between the POS column 111 and the wafer-optical plate 132, both of which are made of magnetic materials.

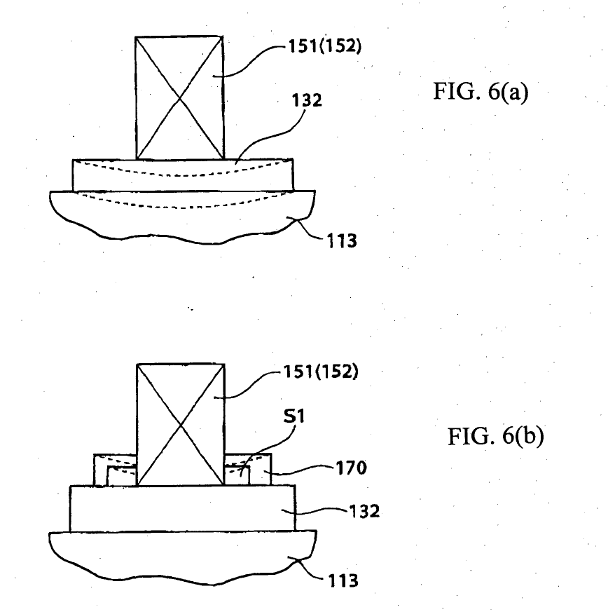

Turning now to FIG. 6(a), a wafer AF system 151 (or wafer AL system 152) and wafer-optical plate 132 lacking a pan 170 are depicted schematically. Atmospheric pressure is exerted on the “top” surface (outside the wafer-vacuum chamber 113) of the wafer-optical plate 132. The “lower” surface of the wafer-optical plate 132 (situated inside the wafer-vacuum chamber 113) normally is subjected to a high vacuum (e.g., 10⁻⁶ Torr). In the absence of the pan 170, during evacuation of the wafer-vacuum chamber 113, or whenever there is a change in atmospheric pressure outside the wafer-vacuum chamber, a corresponding pressure differential (or change in pressure differential) is exerted directly on the wafer-optical plate 132. The pressure differential tends to distort the wafer-optical plate 132 relative to the wafer-vacuum chamber 113 (downward in the figure), as shown by the dotted line in the figure. Whenever such deformation occurs, an instrument such as the wafer AF system 151, mounted on and supported by the wafer-optical plate 132, is affected adversely by experiencing an alignment and/or positional shift.

In contrast, referring now to FIG. 6(b), the secondary reduced-pressure chamber S1 and the pan 170 are located on the “top” surface (outside the wafer-vacuum chamber 113) of the wafer-optical plate 132. The prevailing external pressure (usually atmospheric) is exerted on the “top” surface of the pan 170, but not directly on the “top” surface of the wafer-optical plate 132. This is because the secondary reduced-pressure chamber S1 located between the pan 170 and the wafer-optical plate 132 serves to isolate the “top” surface of the wafer-optical plate from the pressure outside the wafer-vacuum chamber 113. To such end, the secondary reduced-pressure chamber S1 is evacuated by the vacuum pump 171 (FIG. 2) to a vacuum of approximately 10⁻⁴ Torr, for example, which is a lower pressure than the pressure outside the wafer-vacuum chamber 113. Further by way of example, if the inside of the wafer-vacuum chamber 113 is at a high vacuum (e.g., 10⁻⁶ Torr), the secondary reduced-pressure chamber S1 is at approximately 10⁻⁴ Torr, and the external pressure is atmospheric pressure, most of the pressure differential with respect to outside the wafer-vacuum chamber 113 is imparted to the pan 170, not to the wafer-optical plate 132. This pressure differential of the external pressure relative to the subatmospheric pressure inside the secondary reduced-pressure chamber S1 causes the pan 170 to deform, as indicated by the dotted line in FIG. 6(b), rather than causing deformation of the wafer-optical plate 132. Since the pressure differential thus has virtually no effect on the wafer-optical plate 132, deformation of the wafer-optical plate 132 is substantially reduced compared to conventional systems lacking a secondary reduced-pressure chamber. Since the respective spaces between the pan 170 and the wafer AF system 151 are sealed by the respective closure members 186, 192 and O-rings 188, 194 (in a manner allowing a small amount of movement of the pan 170 relative to the wafer-optical plate 132), deformation of the pan 170 has substantially no effect on the wafer AF system 151.

Meanwhile, since deformation of the wafer-optical plate 132 is reduced substantially, as described above, movements of the AF lens column 156a, the mirror chamber 161 supporting the wafer AF system 151, and the legs 166 supporting the stand 165 are reduced substantially. This reduction of deformation of the wafer-optical plate 132 allows focusing and registration to be performed with higher accuracy than previously, which, in turn, allows higher-accuracy lithographic exposures to be made.

If any residual deformation or a change in deformation of the wafer-optical plate 132 becomes problematic, these deformations can be detected using a pressure sensor or deformation sensor (e.g., strain gauge). Data from the sensor can be used in feedback control of the pressure in the secondary reduced-pressure chamber S1, making it possible to cancel the residual or change in deformation.

Whereas the invention has been described in the context of representative embodiments, the invention is not limited to those embodiments. On the contrary, the invention is intended to encompass all modifications, alternatives, and equivalents as may be included within the spirit and scope of the invention, as defined by the appended claims.

What is claimed is:

1. A chamber for holding an object at a pressure that is lower inside the chamber than outside the chamber, comprising:
walls and at least one bulkhead that collectively define the chamber;
a secondary wall situated outside the chamber relative to the bulkhead and defining a gap between the secondary wall and the bulkhead, the gap defining a secondary reduced-pressure chamber that is maintained at a pressure that is lower than the pressure outside the chamber, and the secondary wall being deformable relative to the bulkhead in response to a differential of pressure inside the secondary reduced-pressure chamber relative to the pressure outside the chamber.

2. The chamber of claim 1, wherein the secondary reduced-pressure chamber is isolated from the pressure outside the chamber and from the pressure inside the chamber.

3. The chamber of claim 1, wherein:
the chamber is configured to be evacuated to a vacuum level relative to atmospheric pressure outside the chamber; and
the secondary reduced-pressure chamber is connected to a vacuum pump configured to evacuate the secondary reduced-pressure chamber to a pressure that is lower than the atmospheric pressure outside the chamber.

4. The chamber of claim 1, further comprising:
a measurement instrument mounted to the bulkhead and having a portion extending through the secondary wall to outside the chamber; and
seal means situated and configured to seal the secondary wall to the measurement instrument while allowing the secondary wall to move relative to the measurement instrument, without breaching the seal, in response to the differential of pressure.

5. The chamber of claim 4, wherein the measurement instrument is configured to measure a characteristic of the object inside the chamber.

6. The chamber of claim 4, wherein the seal means comprises an elastomeric sealing member extending from the secondary wall to the measurement instrument.

7. The chamber of claim 4, wherein:
the chamber is a wafer-vacuum chamber of a microlithography system;
the object is a semiconductor wafer being processed lithographically in the wafer-vacuum chamber; and
the measurement instrument is configured for measuring at least one of position and alignment of the semiconductor wafer inside the wafer-vacuum chamber.

8. The chamber of claim 4, wherein:
the chamber is a reticle-vacuum chamber of a microlithography system;
the object is a reticle; and
the measurement instrument is configured for measuring at least one of position and alignment of the reticle inside the reticle-vacuum chamber.

9. The chamber of claim 1, wherein:
the pressure inside the chamber is at a vacuum level; and
the pressure inside the secondary reduced-pressure chamber is a higher vacuum level than inside the chamber.

10. The chamber of claim 1, wherein:
the pressure inside the chamber is at a vacuum level; and
the pressure inside the secondary reduced-pressure chamber is a respective vacuum level that is intermediate the vacuum level inside the chamber and the pressure outside the chamber.

11. The chamber of claim 1, configured as a wafer-vacuum chamber or reticle-vacuum chamber in a microlithography system.

12. An apparatus for housing an object in a subatmospheric-pressure environment, comprising:
a chamber collectively defined by vessel walls and at least one bulkhead, the chamber being sized to contain the object and to contain an atmosphere evacuated to the subatmospheric pressure;
at least one instrument mounted to the bulkhead outside the chamber, the instrument being configured to measure a characteristic of the object in the chamber; and
a deformation-reducing device for reducing deformation of the bulkhead in response to a pressure differential of the subatmospheric pressure inside the chamber relative to pressure outside the chamber.

13. The apparatus of claim 12, wherein:
the deformation-reducing device comprises a secondary wall situated outside the chamber relative to the bulkhead and defining a gap between the bulkhead and the secondary wall; and
the gap defines a secondary reduced-pressure chamber that is evacuated to a pressure that is lower than the pressure outside the chamber.

14. The apparatus of claim 13, wherein the secondary wall is configured to deform relative to the bulkhead in response to the pressure differential of the pressure inside the secondary reduced-pressure chamber relative to the pressure outside the chamber.

15. The apparatus of claim 13, further comprising seal means situated between and establishing a seal between the secondary wall and the instrument, the seal means allowing the secondary wall to move relative to the instrument in response to the differential of pressure, without breaching the seal.

16. The apparatus of claim 15, wherein the seal means comprises an elastomeric sealing member extending from the secondary wall to the measurement instrument.

17. The apparatus of claim 15, wherein:
the instrument is mounted to an instrument-mounting member mounted to the bulkhead; and
the seal means comprises an elastomeric sealing member extending from the secondary wall to the instrument-mounting member.

18. The apparatus of claim 13, further comprising a vacuum pump connected to the secondary reduced-pressure chamber and configured to evacuate the secondary reduced-pressure chamber to the respective pressure in the secondary reduced-pressure chamber.

19. The apparatus of claim 12, further comprising a stage situated inside the chamber and configured to hold the object inside the chamber.

20. The apparatus of claim 19, wherein:
the object is a reticle or substrate; and
the stage is a reticle stage or a wafer stage, respectively, of a microlithographic projection-exposure system.

21. The apparatus of claim 20, wherein the instrument is selected from a group consisting of reticle-autofocus devices, reticle-alignment devices, wafer-autofocus devices, and wafer-alignment devices.

22. A system for irradiating an object with an energy beam, comprising:
a chamber collectively defined by vessel walls and at least one bulkhead, the chamber being sized to contain the object for irradiation with the energy beam and to contain an atmosphere evacuated, at least during the irradiation, to a subatmospheric pressure;
an optical system situated so as to irradiate the object in the chamber with the energy beam;
an instrument, mounted to the bulkhead outside the chamber, configured to measure a characteristic of the object in the chamber; and
a deformation-reducing device for reducing deformation of the bulkhead in response to a differential of pressure inside the chamber relative to pressure outside the chamber.

23. The system of claim 22, wherein:
the deformation-reducing device comprises a secondary wall situated outside the chamber relative to the bulkhead and defining a gap between the bulkhead and the secondary wall; and
the gap defines a secondary reduced-pressure chamber that is evacuated to a pressure that is lower than the pressure outside the chamber.

24. The system of claim 23, wherein the secondary wall is configured to deform relative to the bulkhead in response to a differential of pressure inside the secondary reduced-pressure chamber relative to the pressure outside the chamber.

25. The system of claim 23, further comprising seal means situated between and establishing a seal between the secondary wall and the instrument, the seal means allowing the secondary wall to move relative to the instrument in response to the differential of pressure, without breaching the seal.

26. The system of claim 25, wherein the seal means comprises an elastomeric sealing member extending from the secondary wall to the measurement instrument.

27. The system of claim 25, wherein:
the instrument is mounted to an instrument-mounting member mounted to the bulkhead; and
the seal means comprises a closure member extending from the secondary wall to the instrument-mounting member, and an elastomeric sealing member extending from the closure member to the instrument-mounting member.

28. The system of claim 23, further comprising a vacuum pump connected to the secondary reduced-pressure chamber and configured to evacuate the secondary reduced-pressure chamber to the respective subatmospheric pressure.

29. The system of claim 22, wherein:
the object is a lithographic wafer substrate; and
the optical system is a projection-optical system situated relative to the chamber and configured to illuminate and expose the substrate inside the chamber with an energy beam.

30. The system of claim 29, wherein the energy beam is selected from the group consisting of electromagnetic-radiation beams and charged particle beams.

31. The system of claim 22, wherein:
the object is a reticle; and
the optical system is an illumination-optical system situated relative to the chamber and configured to illuminate the reticle inside the chamber with an energy beam.

32. The system of claim 31, wherein the energy beam is selected from the group consisting of electromagnetic-radiation beams and charged particle beams.

33. A lithographic exposure system for exposing a substrate with a pattern, the system comprising:
a first chamber collectively defined by respective chamber walls and at least one respective bulkhead, the first chamber being configured (a) to contain the substrate for exposure, (b) to allow irradiation of the substrate with an energy beam capable of imprinting the pattern on the substrate, and (c) to contain an atmosphere evacuated, at least during the exposure, to a respective subatmospheric pressure;
a source of the energy beam situated relative to the first chamber to direct the energy beam into the first chamber to expose the substrate;
a respective instrument mounted to the respective bulkhead, the instrument being configured to measure a characteristic of the substrate in the first chamber; and
a respective deformation-reducing device for reducing deformation of the bulkhead of the first chamber in response to a differential of pressure inside the first chamber relative to pressure outside the first chamber.

34. The system of claim 33, wherein the instrument is configured to measure at least one of position and alignment of the substrate in the first chamber.

35. The system of claim 33, wherein the source comprises a projection-optical system coupled to the bulkhead of the first chamber.

36. The system of claim 35, further comprising a second chamber collectively defined by respective chamber walls and at least one respective bulkhead, the second chamber being configured (a) to contain a reticle, (b) to allow irradiation of the reticle with an illumination beam, (c) to allow the illumination beam, propagating downstream of the reticle, to pass from the second chamber to the first chamber, and (d) to contain an atmosphere evacuated, at least during exposure, to a respective subatmospheric pressure;
an illumination-optical system situated relative to the second chamber and configured to direct the illumination beam into the second chamber to illuminate the reticle;
a respective instrument mounted to the respective bulkhead outside the second chamber, the instrument being configured to measure a characteristic of the reticle in the second chamber; and
a respective deformation-reducing device for reducing deformation of the bulkhead of the second chamber in response to a differential of pressure inside the second chamber relative to pressure outside the second chamber.

37. The apparatus of claim 36, wherein, with respect to the second chamber, the respective instrument is configured to measure at least one of position and alignment of the reticle in the second chamber.

38. The system of claim 36, wherein, with respect to the second chamber:
the deformation-reducing device comprises a respective secondary wall situated outside the second chamber relative to the respective bulkhead and defining a gap between the respective bulkhead and the respective secondary wall; and
the gap defines a respective secondary reduced-pressure chamber that is evacuated to a subatmospheric pressure that is lower than the pressure outside the second chamber.

39. The system of claim 38, wherein, with respect to the second chamber, the respective secondary wall is configured to deform relative to the respective bulkhead in response to a differential of pressure inside the respective secondary reduced-pressure chamber relative to the pressure outside the second chamber.

40. The system of claim 38, further comprising, with respect to the second chamber, respective seal means situated and establishing a seal between the respective secondary wall and the respective instrument, the seal means allowing the respective secondary wall to move relative to the respective instrument in response to the differential of pressure, without breaching the seal.

41. The system of claim 40, wherein, with respect to the second chamber, the seal means comprises an elastomeric sealing member extending from a surface of the respective secondary wall to the instrument.

42. The system of claim 38, further comprising a vacuum pump connected to the secondary reduced-pressure chamber of the second chamber and configured to evacuate the secondary reduced-pressure chamber to the respective subatmospheric pressure.

43. The system of claim 42, wherein, with respect to the second chamber, the vacuum pump is further configured to change the subatmospheric pressure in the respective secondary reduced-pressure chamber in response to a change in pressure outside the second chamber.

44. The system of claim 36, wherein:
the projection-optical system comprises a first end coupled to the bulkhead of the first chamber;
the projection-optical system has a second end coupled to the bulkhead of the second chamber; and
the illumination beam passes from the reticle in the second chamber through the projection-optical system to the substrate in the first chamber.

45. The system of claim 33, wherein, with respect to the first chamber:
the deformation-reducing device comprises a respective secondary wall situated outside the first chamber relative to the respective bulkhead and defining a gap between the respective bulkhead and the respective secondary wall; and
the gap defines a respective secondary reduced-pressure chamber that is evacuated to a subatmospheric pressure that is lower than the pressure outside the first chamber.

46. The system of claim 45, wherein, with respect to the first chamber, the respective secondary wall is configured to deform relative to the respective bulkhead in response to a differential of pressure inside the respective secondary reduced-pressure chamber relative to the pressure outside the first chamber.

47. The system of claim 45, further comprising, with respect to the first chamber, seal means situated and establishing a seal between the respective secondary wall and the respective instrument, the seal means allowing the respective secondary wall to move relative to the respective instrument in response to the differential of pressure, without breaching the seal.

48. The system of claim 47, wherein, with respect to the first chamber, the seal means comprises an elastomeric sealing member extending from a surface of the respective secondary wall to the instrument.

49. The system of claim 45, further comprising a vacuum pump connected to the secondary reduced-pressure chamber of the first chamber and configured to evacuate the secondary reduced-pressure chamber to the respective subatmospheric pressure.

50. The system of claim 49, wherein, with respect to the first chamber, the vacuum pump is further configured to change the subatmospheric pressure in the respective secondary reduced-pressure chamber in response to a change in pressure outside the first chamber.

51. In a method for holding processing a workpiece under a subatmospheric-pressure condition established within a chamber collectively defined by vessel walls and at least one bulkhead, a method for reducing deformations of the bulkhead resulting from changes in a differential of pressure inside the chamber relative to pressure outside the chamber, the method comprising:
placing a secondary wall outside the chamber relative to the bulkhead so as to define a gap between the secondary wall and the bulkhead, the gap defining a secondary reduced-pressure chamber; and
evacuating the secondary reduced-pressure chamber to a subatmospheric pressure that is lower than the pressure outside the chamber, wherein the secondary wall deforms relative to the bulkhead in response to a differential of pressure inside the secondary reduced-pressure chamber relative to the pressure outside the chamber.

52. The method of claim 51, wherein the pressure in the secondary reduced-pressure chamber is lower than the pressure inside the chamber.

53. The method of claim 51, wherein the pressure in the secondary reduced-pressure chamber is intermediate the pressure inside the chamber and the pressure outside the chamber.

54. A microlithography system that illuminates a selected region on a pattern-defining reticle with an energy beam, and projects and focuses the energy beam, propagating from the reticle, onto a selected region on a sensitive substrate so as to transfer the pattern from the reticle to the sensitive substrate, the microlithography system comprising:
a reticle-vacuum chamber containing a reticle stage on which the reticle is mounted, the reticle-vacuum chamber being defined by respective walls and at least one respective bulkhead;
a wafer-vacuum chamber containing a wafer stage on which the sensitive substrate is mounted, the wafer-vacuum chamber being defined by respective walls and at least one respective bulkhead;
a respective instrument mounted on the bulkhead of the reticle-vacuum chamber and configured to measure a characteristic of the reticle;
a respective instrument mounted on the bulkhead of the wafer-vacuum chamber and configured to measure a characteristic of the substrate; and
a deformation-reducing device for reducing deformation of the respective bulkhead of at least one of the chambers in response to a differential of pressure inside the respective chamber relative to pressure outside the respective chamber.

55. The system of claim 54, wherein:
the deformation-reducing device comprises a respective secondary wall situated outside the respective chamber relative to the respective bulkhead and defining a gap between the respective bulkhead and the respective secondary wall; and
the gap defines a respective secondary reduced-pressure chamber that is evacuated to a respective subatmospheric pressure that is lower than the pressure outside the respective chamber.

56. The system of claim 55, wherein the pressure in the respective secondary reduced-pressure chamber is lower than the pressure inside the respective chamber.

57. The system of claim 55, wherein the pressure in the respective secondary reduced-pressure chamber is intermediate the pressure inside the respective chamber and the pressure outside the respective chamber.

58. The system of claim 55, wherein the secondary wall is configured to deform relative to the respective bulkhead in response to a differential of pressure inside the respective secondary reduced-pressure chamber relative to pressure outside the respective chamber.

59. The system of claim 55, wherein the respective secondary reduced-pressure chamber further comprises seal means situated and establishing a seal between the respective secondary wall and the respective instrument, the seal means allowing the respective secondary wall to move relative to the respective instrument in response to the differential of pressure, without breaching the seal.

60. The system of claim 59, wherein the seal means comprises an elastomeric sealing member extending from a surface of the secondary wall to the respective instrument.

61. The system of claim 55, further comprising a respective vacuum pump connected to the secondary reduced-pressure chamber and configured to evacuate the secondary reduced-pressure chamber to the respective subatmospheric pressure.

62. The system of claim 54, comprising a first deformation-reducing device for reducing deformation of the bulkhead of the reticle-vacuum chamber, and a second deformation-reducing device for reducing deformation of the wafer-vacuum chamber, in response to respective pressure differentials being established in the respective chambers relative to outside the respective chambers.

63. The system of claim 62, wherein each deformation-reducing device comprises:
a respective secondary wall situated outside the respective chamber relative to the respective bulkhead and defining a respective gap between the respective bulkhead and respective secondary wall; and
each respective gap defines a respective secondary reduced-pressure chamber that is evacuated to a respective subatmospheric pressure that is lower than the pressure outside the respective chamber.

64. The system of claim 63, wherein each secondary wall is configured to deform relative to the respective bulkhead in response to a differential of pressure inside the respective secondary reduced-pressure chamber relative to pressure outside the respective chamber.

65. The system of claim 63, wherein each deformation-reducing device further comprises a respective seal means situated and establishing a seal between each respective secondary wall and the respective instrument, the seal means allowing the respective secondary wall to move relative to the respective instrument in response to the respective differential of pressure, without breaching the respective seal.

66. The system of claim 65, wherein each seal means comprises an elastomeric sealing member extending from a surface of the respective secondary wall to the respective instrument.

67. The system of claim 66, further comprising a respective vacuum pump connected to the respective secondary reduced-pressure chamber and configured to evacuate the respective secondary reduced-pressure chamber to the respective subatmospheric pressure.

68. The system of claim 63, wherein:
the respective instrument mounted on the bulkhead of the reticle-vacuum chamber is selected from the group consisting of reticle-position-measurement systems and reticle-alignment-measurement systems; and
the respective instrument mounted on the bulkhead of the wafer-vacuum chamber is selected from the group consisting of substrate-position-measurement systems and substrate-alignment-measurement systems.

69. The system of claim 62, wherein the bulkhead of the reticle-vacuum chamber and the bulkhead of the wafer-vacuum chamber are mounted to opposite respective ends of a projection-optical system extending between and outside the chambers.

70. The system of claim 69, wherein:
the bulkhead of the reticle-vacuum chamber is configured as a reticle-optical plate; and
the bulkhead of the wafer-vacuum chamber is configured as a wafer-optical plate.

71. The system of claim 69, wherein:
the reticle-vacuum chamber comprises a second respective bulkhead situated opposite the respective bulkhead relative to the respective walls; and
the second bulkhead is connected to an illumination-optical system.

72. The system of claim 54, wherein:
the reticle-vacuum chamber is coupled to a reticle-loader chamber and a reticle load-lock chamber; and
the wafer-vacuum chamber is coupled to a wafer-loader chamber and a wafer load-lock chamber.

73. A chamber for holding an object, comprising:
walls and at least one bulkhead means that collectively define the chamber that contains an atmosphere at a respective pressure; and
deformation-reducing means for reducing deformation of the bulkhead means in response to a pressure differential of the pressure inside the chamber relative to pressure outside the chamber.

74. The chamber of claim 73, wherein:
the deformation-reducing means comprises secondary-wall means situated outside the chamber relative to the bulkhead means and defining a gap between the bulkhead means and the secondary-wall means;
the gap defines secondary-reduced-pressure-chamber means in which a respective pressure is lower than the pressure outside the chamber; and
the secondary-wall means deforms relative to the bulkhead means in response to a pressure differential of the pressure inside the secondary-reduced-pressure-chamber means relative to the pressure outside the chamber.

75. The chamber of claim 74, further comprising:
instrument means mounted to the bulkhead means outside the chamber; and
seal means for establishing a seal between the secondary-wall means and the instrument means, and allowing the secondary-wall means to move relative to the instrument means, in response to the pressure differential, without breaching the seal.
